(19) United States
(12) Patent Application Publication
(10) Pub. No.: US 2017/0163082 A1
(43) Pub. Date: Jun. 8, 2017

(54) ELECTRIC VOLTAGE SYSTEM AND METHOD FOR CHARGING A BATTERY OF AN ELECTRIC VOLTAGE SYSTEM

(71) Applicant: VOLKSWAGEN AG, Wolfsburg (DE)

(72) Inventors: Wolfgang SAUCKE, Wittingen (DE); Florian KÜHNLENZ, Barwedel (DE); Daniel URBSCHAT, Braunschweig (DE)

(73) Assignee: Volkswagen AG

(21) Appl. No.: 15/251,756

(22) Filed: Aug. 30, 2016

(30) Foreign Application Priority Data
Dec. 2, 2015 (DE) 10 2015 224 092.4

(51) Int. Cl. H02J 7/35; H02J 3/38; H02J 7/00; B60L 11/18

(52) U.S. Cl. CPC H02J 7/35; B60L 11/1809; B60L 11/1864; H02J 3/385; H02J 7/0047; H02J 7/007; B60L 11/1861; B60L 2210/10

(57) ABSTRACT

A high-voltage electrical system having at least one high-voltage battery and one solar module, wherein the high-voltage battery may be galvanically isolated from a voltage connection via at least one switch between a terminal of the high-voltage battery and the voltage connection, wherein at least one control device is associated with the high-voltage battery, which is designed such that the at least one control device generates at least control commands for the switch, wherein at least one DC/DC converter is arranged between the solar module and the high-voltage battery, which is designed such that the high-voltage battery is charged by the solar module, wherein the at least one DC/DC converter is designed as a galvanically isolated DC/DC converter, wherein the outputs of the DC/DC converter are directly connected to the high-voltage battery. Also disclosed is a method for charging a high-voltage battery by a solar module.

### PRIORITY CLAIM

This patent application claims priority to German Patent Application No. 10 2015 224 092.4, filed 2 Dec. 2015, the disclosure of which is incorporated herein by reference in its entirety.

### SUMMARY

Illustrative embodiments relate to a high-voltage electrical system and a method for charging a high-voltage battery of a high-voltage electrical system.

### BRIEF DESCRIPTION OF THE DRAWINGS

The disclosed embodiments will now be described in greater detail with reference to the single drawing.

FIG. 1 shows a schematic block diagram of a high-voltage electrical system.

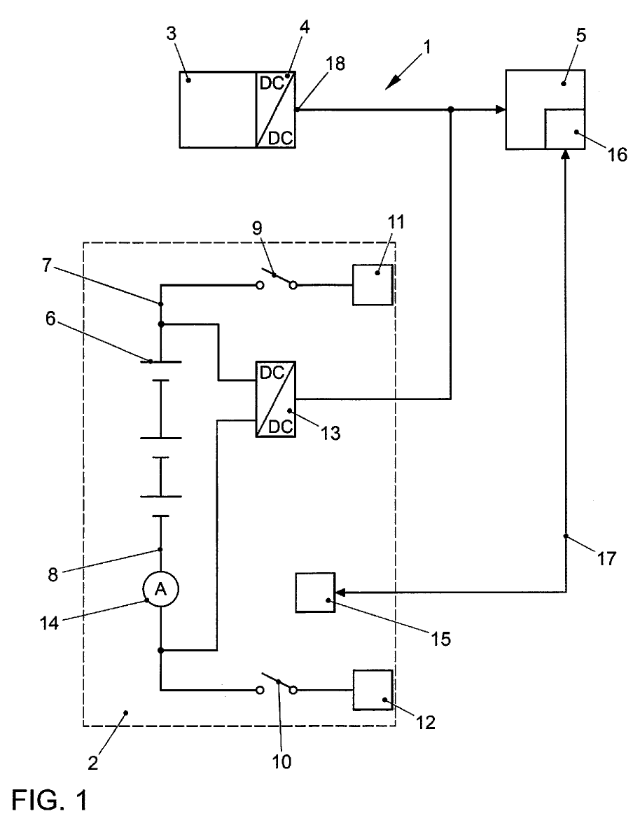

### DETAILED DESCRIPTION

One possible area of application of high-voltage electrical systems is the electric drive train of electric or hybrid vehicles, where voltage sources such as high-voltage batteries have voltages of over 60 V up to 400 V and higher. In this case, at least one control device is associated with the high-voltage batteries. Due to the voltages of over 60 V, it must be possible to disconnect these high-voltage systems. For this purpose, switches are provided which are able to galvanically isolate at least one terminal of the high-voltage battery from a voltage connection. This switch is controlled by the at least one control device.

To improve the range of electric or hybrid vehicles, it has already been proposed to use electrical energy of a solar module for charging a high-voltage battery of a high-voltage electrical system. The solar module may, for example, be integrated into the roof of a motor vehicle. In principle, the solar module may, however, also be arranged on a roof of a parking space.

DE 10 2009 027 685 A1 discloses a high-voltage electrical system for an electric or hybrid vehicle. In this case, the high-voltage electrical system has a high-voltage battery and a solar module. The electrical energy of the solar module is stored in a temporary store and then subsequently used for charging the high-voltage battery and the low-voltage network with an onboard electrical system battery, via a DC/DC converter. The problem is thus addressed of the efficiency being too low due to the temporary store and the DC/DC converter.

Therefore, DE 10 2009 027 685 A1 discloses another alternative. Under this alternative, the apparatus includes a control device with a connection device for receiving a charge voltage provided by the solar module, wherein the control device is adapted to selectively switch through the charging voltage supplied by the solar module to one or more of the cell blocks of a high-voltage store. In this case, the nominal voltage of the cell blocks is lower than the nominal voltage of the high-voltage store. Furthermore, the apparatus has a measuring device for measuring one or multiple parameters of the multiple cell blocks of the high-voltage store. Finally, the apparatus has a control device for selectively switching through the charging voltage supplied by the solar module to one or more of the cell blocks based on the one or multiple parameters to selectively charge the one or multiple cell blocks.

Disclosed embodiments create an alternative high-voltage electrical system via which the efficiency may be improved and provide an associated method.

Disclosed embodiments provide an apparatus and a method. The high-voltage electrical system includes at least one high-voltage battery and one solar module, wherein the high-voltage battery may be galvanically isolated from a voltage connection via at least one switch between a terminal of the high-voltage battery and the voltage connection. The switch may be a relay, wherein the high-voltage system may have two switches to be able to isolate all terminals of the high-voltage battery. At least one control device is associated with the high-voltage battery, which is designed in such a way that it generates at least control commands for the at least one switch. Furthermore, at least one DC/DC converter is arranged between the solar module and the high-voltage battery, which is designed in such a way that the high-voltage battery is charged by the solar module. In this case, the at least one DC/DC converter is designed as a galvanically isolated DC/DC converter, wherein the outputs of the DC/DC converter are directly connected to the high-voltage battery. The DC/DC converter is, for example, a transformer DC/DC converter. In other words, the DC/DC converter bridges the at least one switch, so that the high-voltage battery may also be charged via the solar module if the switch is open and the control device of the high-voltage battery is sleeping. This saves a considerable amount of energy for energizing the switch and for operating the control device, wherein the high-voltage side remains disconnected due to the design as a galvanically isolated DC/DC converter.

In at least one disclosed embodiment, an additional DC/DC converter is associated with the solar module, whose output is connected to the input of the galvanically isolated DC/DC converter, wherein the DC/DC converter associated with the solar module may have MPPT (maximum power point tracker) functionality. As a result, the efficiency is correspondingly optimized.

In another disclosed embodiment, the output of the DC/DC converter associated with the solar module is connected to a low-voltage onboard electrical system. Thus, the solar module may also be used for charging the low-voltage onboard electrical system, for example, to supply consumers and/or to charge a low-voltage onboard electrical system battery.

In another disclosed embodiment, the galvanically isolated DC/DC converter is controllable via at least one additional control device, wherein the high-voltage system has means for detecting or estimating the current flowing into the high-voltage battery, wherein the control device is designed in such a way that the galvanically isolated DC/DC converter is deactivated as a function of the detected or estimated current. Thus, overcharging of the high-voltage battery is prevented. In this case, for example, the charging current may be estimated based on the output current of the DC/DC converter associated with the solar module. However, the output current of the galvanically isolated DC/DC converter may also be ascertained, or the current flowing into the high-voltage battery may also be directly measured.

In another disclosed embodiment, the control device is designed in such a way that it wakes up the control device of the high-voltage battery after a deactivation of the DC/DC converter, wherein the control device of the high-voltage battery is designed in such a way that it carries out a determination of the state of charge of the high-voltage battery, so that the actual state of charge is ascertained.

In another disclosed embodiment, the control device of the high-voltage battery is designed in such a way that it communicates a detected state of charge of the high-voltage battery to the other control device, wherein this control device enables the galvanically isolated DC/DC converter as a function of the transmitted state of charge of the high-voltage battery, so that the high-voltage battery may be further charged if possible, wherein the control device of the high-voltage battery may go into a sleep mode after the transmission of the state of charge.

One possible area of application is the use in an electric or hybrid vehicle.

The high-voltage electrical system 1 has a high-voltage battery module 2, a solar module 3 with a downstream DC/DC converter 4, and a low-voltage onboard electrical system 5.

The high-voltage battery module 2 has a high-voltage battery 6 with a positive terminal 7 and a negative terminal 8, which are routed in each case to a voltage connection 11, 12 via a switch 9, 10. Furthermore, the high-voltage battery module 2 has a galvanically isolated DC/DC converter 13, a current sensor 14, and a control device 15 which is connected to a control device 16 of the low-voltage onboard electrical system 5 via a bus system 17.

In the deactivated state, the switches 9, 10 are open and the control device 15 is sleeping. Thus, the high-voltage side of the high-voltage systems 1 is galvanically isolated, and the high-voltage battery module 2 has only minimal quiescent current consumption. The solar module 3 converts sunlight into voltage, which is then converted by means of the DC/DC converter 4 with MPPT functionality into a constant output voltage of, for example, 12 V, and is available for supplying the low-voltage onboard electrical system 5. An output 18 of the DC/DC converter 4 is additionally connected to the galvanically isolated DC/DC converter 13. For the sake of simplicity, only one voltage line is shown, since, on the low-voltage side, the negative voltage line is, for example, the vehicle ground. The DC/DC converter 13 is controlled by the control device 16 of the low-voltage onboard electrical system 5. Thus, the high-voltage battery 6 may also be charged, although the switches 9, 10 are open and the control device 15 is sleeping. The control device 16 has a state of charge SOC of the high-voltage battery 6. For example, the control device 15 transmitted the state of charge SOC to the control device 16 before it went into sleep mode. During the charging process of the high-voltage battery 6, the control device 16 estimates how much it has been charged. For this purpose, the control device 16 accesses the data of the current sensor 14 or output current data of the DC/DC converter 13.

If, in the view of the control device 16, a certain state of charge SOC of the high-voltage battery 6 has been achieved, the DC/DC converter 13 is deactivated to prevent overcharging. In addition, the control device 16 may wake the control device 15, so that it makes a precise SOC measurement and performs cell balancing as necessary. The control device 15 may then transmit the result of the SOC measurement to the control device 16, which then continues the charging process as necessary, as a function of the state of charge, by activating or enabling the DC/DC converter 13. For this purpose, the control device 15 is not required and may again go into sleep mode.

1. A high-voltage electrical system, comprising at least one high-voltage battery and one solar module,
wherein the high-voltage battery is galvanically isolated from a voltage connection via at least one switch between a terminal of the high-voltage battery and the voltage connection,
wherein at least one control device is associated with the high-voltage battery, which is designed such that the at least one control device generates at least control commands for the switch,
wherein at least one DC/DC converter is arranged between the solar module and the high-voltage battery, which is designed such that the high-voltage battery is charged by the solar module, and
wherein the at least one DC/DC converter is designed as a galvanically isolated DC/DC converter, wherein the outputs of the DC/DC converter are directly connected to the high-voltage battery.

2. The high-voltage electrical system of claim 1, wherein an additional DC/DC converter is associated with the solar module and has an output connected to the input of the galvanically isolated DC/DC converter.

3. The high-voltage electrical system of claim 2, wherein the output of the DC/DC converter associated with the solar module is connected to a low-voltage onboard electrical system.

4. The high-voltage electrical system of claim 2, wherein the DC/DC converter associated with the solar module has MPPT functionality.

5. The high-voltage electrical system of claim 1, wherein the galvanically isolated DC/DC converter is controllable via at least one additional control device, and the high-voltage system detects or estimates the current flowing into the high-voltage battery, wherein the control device is designed such that the galvanically isolated DC/DC converter is deactivated as a function of the detected or estimated current.

6. The high-voltage electrical system of claim 5, wherein the control device is designed such that the high-voltage electrical system wakes up the control device of the high-voltage battery after a deactivation of the DC/DC converter, and wherein the control device of the high-voltage battery is designed such that the control device carries out a determination of the state of charge of the high-voltage battery.

7. The high-voltage electrical system of claim 6, wherein the control device of the high-voltage battery is designed to communicate a detected state of charge of the high-voltage battery to the other control device, wherein this control device enables the DC/DC converter as a function of the transmitted state of charge of the high-voltage battery.

8. The high-voltage electrical system of claim 7, wherein the control device of the high-voltage battery is designed to go into a sleep mode after the transmission of the state of charge.

9. A method for charging a high-voltage battery of a high-voltage electrical system by a solar module, the method comprising:
galvanically isolating the high-voltage battery from a voltage connection via at least one switch between a terminal of the high-voltage battery and the voltage connection;
generating at least control commands for the switch using at least one control device associated with the high-voltage battery;
arranging at least one DC/DC converter between the solar module and the high-voltage battery for charging by the solar module,
wherein the at least one DC/DC converter is designed as a galvanically isolated DC/DC converter, wherein the outputs of the DC/DC converter are directly connected to the high-voltage battery,
wherein the charging of the high-voltage battery takes place with an open switch.

10. The method of claim 9, further comprising estimating or ascertaining the state of charge of the high-voltage battery due to the charging process and deactivating the DC/DC converter as a function of the state of charge.
